(19) United States
(12) Patent Application Publication
(10) Pub. No.: US 2008/0094178 A1
(43) Pub. Date: Apr. 24, 2008

(54) RFID SYSTEM AND RFID METHOD

(76) Inventor: Franz Angerer, Muhldorf (DE)

Correspondence Address: PEARNE & GORDON LLP, 1801 EAST 9TH STREET, SUITE 1200, CLEVELAND, OH, 44114-3108, US

(21) Appl. No.: 11/874,746

(22) Filed: Oct. 18, 2007

(30) Foreign Application Priority Data
Oct. 20, 2006 (DE) 10 2006 049 579.9

(51) Int. Cl. H04Q 5/22

(52) U.S. Cl. 340/10.1

(57) ABSTRACT

The invention concerns the field of RFID (“radio frequency identification”), a technology for the wireless identification of objects, which has been used for a considerable time for the automatic retrieval of information regarding persons, animals, commodities and goods items. In particular the invention concerns an RFID system (10b) with at least one reading unit (12b) for the identification of transponders (14b), which are located in a spatial registration field (16b) of the reading unit (12b). While maintaining low installation and operating costs for the system (10b), nevertheless to make possible particularly reliable registration and error-free identification of the transponders, shielding (20b) is provided, which bounds the registration field (16b). Particularly advantageously the invention can be integrated e.g. into materials handling technology in the field of production and/or logistics.

### BACKGROUND TO THE INVENTION

1. Field of the Invention

The present invention concerns an RFID system and an RFID method with at least one reading unit for the identification of transponders, which are located in a spatial registration field of the reading unit.

2. Description of the Prior Art

RFID (“radio frequency identification”) is a technology for the wireless identification of objects that has been used for a considerable time in the field of so-called auto-ID, in other words the automatic retrieval of information regarding persons, animals, commodities and goods items.

Every auto-ID system is based on the use of artificial identification features to enable machine-based identification. Barcode labels, still widely used today, which many years ago revolutionised the field of auto-ID, are becoming of less and less interest for applications currently gaining in significance. Barcodes are often disadvantaged by their low storage information capacity, and also by the fact that this information cannot be modified retrospectively. Moreover the read-out or read-off (“scanning”) of data is relatively laborious and time-consuming (as visual contact is required).

These disadvantages can be removed with RFID. Therefore one can assume that RFID systems and methods in the future will replace e.g. barcodes in many applications, and in addition will revolutionise the field of auto-ID in a similar manner as a result of their ability to be used in totally new applications.

A wide variety of RFID systems and methods are known per se. Just as an example reference can be made to the “RFID-Handbuch [RFID Manual]”, 3rd edition, Klaus Finkenzeller, Carl Hanser Verlag, Munich and Vienna, 2002.

An RFID system consists of at least one reading unit for the read-out of data that are stored in a transponder, wherein the data transfer between transponder and reading unit takes place by means of electromagnetic waves. At lower frequencies this occurs inductively via the near field, at higher frequencies via the electromagnetic far field. The reading unit can function, as can the transponder, both as a transmitter and also as a receiver for the electromagnetic radiation. Inductively coupled systems possess a comparatively short range. Typical representatives of this variant are e.g. contact-less chip cards and automatic access systems. In contrast systems with electromagnetic far field coupling possess a comparatively long range. The present invention relates in particular to this latter group of RFID systems and methods. Established frequencies for RFID systems with far field coupling are of the order of several hundred MHz. In legal terms closely defined frequency ranges are often prescribed, such as, e.g. 865-869.5 MHz, or 2.45 GHz.

For the transponders, which e.g. in particular are applied in the form of labels or similar to commodities or goods items, or can be integrated into their packaging, one can differentiate between various types:

Active transponders possess their own power supply, e.g. in the form of a battery.

Passive transponders, on the other hand, use the radiation energy of an RFID transmitter (which e.g. can be integrated in the reading unit) to transmit their own information to the reading unit. The invention can be used very advantageously in particular for this latter type of transponder.

So-called semi-passive transponders represent a mixed form, which e.g. are just fitted with a low power back-up battery that is used to send the transponder's own information as soon as it has been “woken up” by the RFID system (e.g. by the reading unit).

In the RFID systems and methods currently in use a large number of problems occur in practice, which make utilisation of the RFID technology in some areas of application difficult if not impossible.

A first series of problems concerns the reliability of the technology. In this respect the requirement exists to identify all transponders located in the registration field of the reading unit in question and to read out the data stored in these transponders in an error-free manner (and if necessary to modify the data in an error-free manner). In practice however this is prevented, e.g. by interference of a plurality of RFID reading units with each other, by interference as a result of spontaneous radio emissions in the vicinity, by interference from other radio equipment and sometimes by sabotage from a jamming transmitter.

Data security represents a further set of problems. In this regard there exists e.g. the risk of eavesdropping on data communication, and the risk of falsification of information. The communication between an RFID reading unit and transponders can essentially be compared with a normal radio link between a transmitter and a receiver. An external eavesdropper can listen to, falsify, or simulate individual bit patterns, or can render the receiver unserviceable as a result of an information overload similar to a so-called denial of service (DoS) attack. What is particularly paradoxical is the situation with regard to the fact that many well-known manufacturers wish to use RFID for plagiarism protection. Here eavesdropping attacks and import of falsified information from external sources are bound to occur.

Both sets of problems elucidated above have in the past led to RFID systems becoming ever more complex, requiring a high level of resource for implementation, in other words ultimately the trend has been for the costs of implementation and operation to increase.

### SUMMARY OF THE INVENTION

An object of the present invention is therefore to specify an RFID system and method that enable reliable registration of the transponders with low installation and operating costs.

This object is achieved according to the invention by means of shielding of the registration field.

In the RFID system according to the invention the registration field of the reading unit is bounded by the shielding so that the reliability can be considerably improved without complicating the system appreciably.

With the shielding on the one hand an insensitivity of the identification process is created to a greater or lesser extent with respect to external interference radiation and on the other hand the possibility of attacks from external sources (e.g. sabotage, eavesdropping, import of false information) is considerably reduced or even excluded. A large number of options are advantageously available to the person skilled in the art for the technical implementation of the shielding.

In a preferred form of embodiment the shielding surrounds the registration field for the most part, in particular essentially completely.

In one form of embodiment the shielding is designed such that it absorbs at least 50%, in particular at least 60%, of a radiation power output of the system.

In most countries RFID systems, as technical radio equipment, are subject to very restrictive legal directives. These directives can relate e.g. to the frequencies of the electromagnetic radiation used and/or the power outputs with which the one or more transmitters of the system are operated. In this regard a surprising advantage of the invention consists in the fact that the RFID system, according to the form of embodiment, can be operated practically independently of such legal directives. Advantageously such a system can be implemented worldwide at any place at any time and with any radio wavelength and power output.

In one form of embodiment provision is made that a radiation wavelength of the system lies in a range from 0.8 to 8 GHz.

In one form of embodiment provision is made that a radiation wavelength of the system lies in a range that is legally prohibited for the operation of technical radio equipment.

In one preferred form of embodiment a radiation power output of the system is dimensioned to be so large that operation of the system without the shielding would be legally prohibited. This radiation power output can be larger e.g. by at least a factor 2, in particular by at least a factor 5, than the permissible radiation power output (without shielding).

In one form of embodiment provision is made that the RFID transmission power output of a reading unit is at least 5 W, in particular at least 10 W.

In addition to an increase in transmission power output above the relevant standard (for better RFID reading results) the option also advantageously comes into consideration of providing RFID transmission and reading units that are simpler, cheaper and more robust with regard to their technical HF construction.

In a manner known per se a flat, extensive, electrically conducting material layer, e.g. a metal sheet or a metal foil, comes into consideration as shielding. However, for the majority of the applications or radiation wavelengths that are of particular interest here the principle of the “Faraday cage” can advantageously be used in the context of the invention, and the shielding can be formed from an electrically conducting lattice or mesh structure.

Such a lattice or mesh structure can advantageously be implemented with comparatively simple, in particular even commercially available, materials. In one form of embodiment the structure comprises e.g. metal bars and/or perforated metal plate and/or wire netting and/or wire mesh. For the formation of a shielding module, for example, individual elements (e.g. metal frames) covered with wire netting can be prefabricated at various sizes.

In particular with the shielding components cited above it is possible to assemble shielding walls, or complete shielding cages, of various sizes in a modular manner from prefabricated parts.

When not using a continuous flat electrically conducting shielding component, but rather a lattice or mesh structure, a characteristic separation distance of the structure (e.g. the mutual separation distance between metal bars, the mesh width of wire netting, or a hole diameter of perforated metal) is dimensioned to be smaller than the wavelength of electromagnetic radiation of the system, preferably by at least a factor 2, in particular by at least a factor 5. For a frequency of approximately 870 MHz, corresponding to a wavelength of about 30 cm, there thus ensues e.g. a characteristic separation distance (e.g. mesh width) of about 15 cm or less (e.g. 3 cm).

In one form of embodiment provision is made that the shielding comprises a plurality of shielding layers arranged one behind another, e.g. two or three lattice or mesh structures of the type cited above. Such a multi-layer shielding structure enables e.g. a greater absorption of radiation power output in the shielding material. Here the plurality of shielding layers can be provided to be of the same type or different types (e.g. with different characteristic separation distances such as e.g. mesh width).

In the context of the present invention a quite other important significance is, however, ascribed to a multi-layer shielding structure, or to the individual shielding components: If the mutual separation distance between shielding layers arranged one behind another is of the order of the relevant radiation wavelength, which for the applications that are of particular interest here can be achieved without any difficulty, then the shielding effect can be dramatically modified in a purposeful manner by the choice of a particular mutual separation distance. According to the actual dimension of this mutual separation distance the electromagnetic waves reflected at the various shielding layers can e.g. destructively or constructively interfere. In the first case minimal reflection and maximum absorption ensues, whereas in the second case the shielding effect includes a maximum reflection component. The damping, i.e. the reduction of the radiation power output by reason of passage through the shielding, thereby remains undisturbed.

Maximum reflection can e.g. be desirable, if one does not wish to have any “dead angles” in terms of radio signals within a registration field bounded by the shielding so that all transponders located in the registration field can be identified particularly reliably.

In the context of the present invention the term “identification” (of transponders) is to be interpreted very widely, and should include all types of information and/or data transfer from the transponder to the reading unit. In the simplest case it takes the form e.g. of “1 bit information” (transponder is in the registration field or not). Of greater practical significance are however more complex data, which are stored in the region of the transponder and are read out at least partly (e.g. a so-called EAN code of a goods item or a “tracking code” of a product in the production material flow). Here it is by no means excluded, and often is in fact preferred, that during the “identification process” information or data transfer takes place in the opposite direction.

In contrast there can be cases, for example if the radiation power output of a reading unit is to be exactly adapted or matched to the aerial of the transponder, in which as large an absorption as possible of transmission power output in the shielding is appropriate.

In one form of embodiment provision is made that at least one part of the shielding is designed as a gate, which in the open position permits the introduction and removal of objects fitted with transponders, and which shields in a closed position.

Here the term “gate” is to be interpreted very widely and includes for example plate-type or door-type moveable shielding components, such as e.g. pivoted doors, sliding doors, swing doors, but e.g. also includes roller gates, roller curtains, folding gates etc. Moreover e.g. the following constructions can be used as gate-type designs for shielding parts: metal-coated louvered roller gate that is automatically opened and closed; louvered curtain of metal-coated plastic (or plastic-coated metal); swing doors of wire netting elements; (louvered) curtain with woven-in wire mesh etc.

In a further development provision is made for at least two gates, of which one is provided for the introduction of the objects and another is provided for their removal.

A particularly preferred use of the RFID system and method according to the invention is the automatic identification of commodities or goods items, in particular e.g. in the field of procurement and distribution logistics, in commercial trade, in production operations, or other material flow systems.

Advantageously the invention can be integrated into materials handling technology in the field of production and/or logistics and can be used in each case in specially adapted variants (e.g. also in transportation services).

In a further development of the invention the RFID system is designed inside a vehicle. Here the registration field of the RFID system is preferably located within a loading space of the vehicle, or forms this loading space. A significant advantage of this further development consists in the fact that the RFID method can be carried out in the vehicle during transport of the relevant objects, in particular goods items.

The vehicle can e.g. take the form of a commercial load-carrying vehicle. In a commercial load-carrying vehicle of conventional construction the rectangular loading space can e.g. be used as a registration field of an RFID system, in that a textile vehicle covering with a shielding effect is used (e.g. a textile covering with a woven-in wire mesh). Also the loading space of the vehicle concerned, in particular a commercial load-carrying vehicle, could be lined with shielding parts or shielding modules.

### SHORT DESCRIPTION OF THE DRAWINGS

In what follows the invention is further described with the aid of examples of embodiment with reference to the accompanying drawings. In the figures:

FIGS. 1 to 6 illustratively represent an interference-free RDIF method according to a first example of embodiment,

FIGS. 7 to 12 correspondingly represent a modified RDIF system according to a second example of embodiment,

FIGS. 13 to 15 correspondingly represent a third example of embodiment,

FIG. 16 shows a fourth example of embodiment of an RDIF system,

FIG. 17 shows a further modified, fifth example of embodiment of an RDIF system,

FIGS. 18 and 19 illustratively represent shielding with a predominantly absorbing shielding effect (FIG. 18) and a predominantly reflecting shielding effect (FIG. 19) respectively,

FIGS. 20 to 25 illustratively represent various technical implementations of the shielding effect,

FIG. 27 shows a sixth example of embodiment of an RDIF system, and

FIG. 26 shows a seventh example of embodiment of an RDIF system.

### DESCRIPTION OF THE PREFERRED FORM(S) OF EMBODIMENT

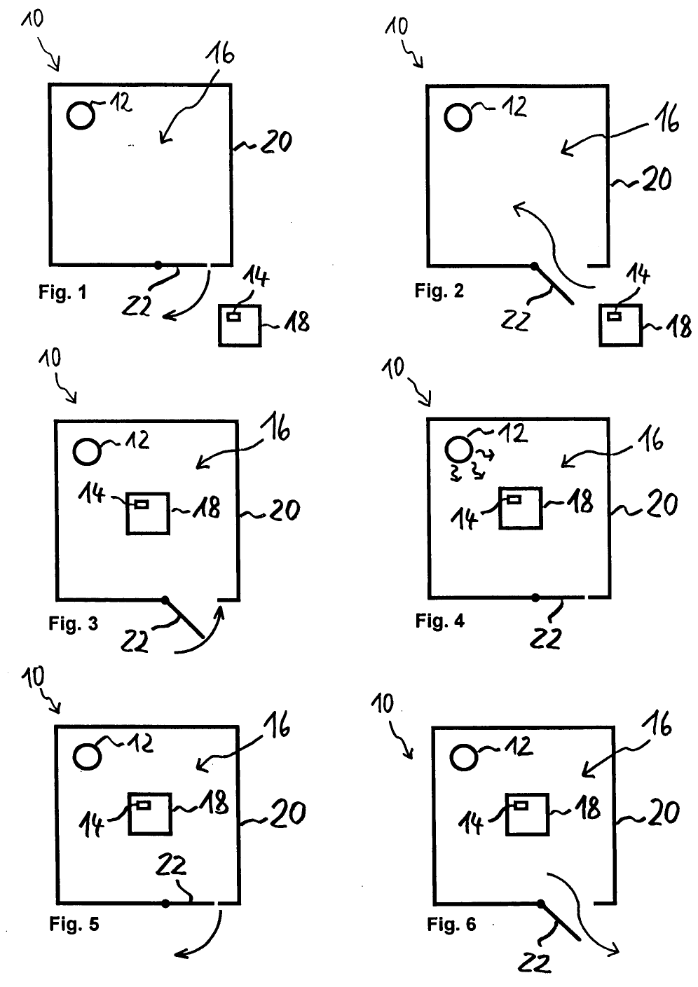

FIGS. 1 to 6 illustrate the sequence of an RFID method using an RFID system 10 with a reading unit 12 for the identification of transponders that are located in a spatial registration field 16 of the reading unit 12.

For simplicity of representation just one such transponder 14 is symbolised in the figures, which takes the form of e.g. an identification label on the packaging of a goods item 18.

A special feature of the system 10 consists in the fact that the registration field 16 is bounded by shielding 20, which in the example of embodiment represented forms the sidewalls of an overall approximately rectangular registration field 16 and thus surrounds the registration field 16 for the most part. Deviating from this configuration the shielding 20 could also e.g. surround the registration field 16 completely in that, for example, shielding components are also provided above and below.

One part of the shielding 20 laterally bounding the registration field 16 is designed as a door 22, which serves for the introduction of the goods items 18 fitted with transponders 14 into the registration field 16 and their removal from the field once again.

FIG. 1 shows the situation before the start of the actual identification process. The goods item 18 to be identified is located outside the registration field 16. The door 22 is then opened and the goods item 18 is brought into the registration field 16, as represented in FIG. 2.

Although just one goods item 18 is represented in FIGS. 1 to 6, a larger number of goods items would actually be involved in practice, for example a full shopping trolley, a large package with a large number of articles located inside it, a pallet of goods items, etc.

The door 22 is then closed (FIG. 3) and the actual RFID is carried out (FIG. 4).

The RFID represented takes place using the reading unit 12, which transmits electromagnetic radiation in a predetermined frequency range (here: UHF) in accordance with an RFID standard. For this purpose the reading unit 12 is provided with one or a plurality of appropriate aerials. The electromagnetic radiation is received in the far field by an aerial of the transponder 14. As for conventional RFID systems known per se, a microchip of the transponder 14 is activated by a current induced in the field of the transponder aerial and at the same time a capacitor is charged up, providing a temporary power supply for the microchip. The transponder 14 is then e.g. in a position to receive and process commands from the reading unit 12. While the transponder 14 is still being exposed to radiation, or subsequently in a “radio intermission”, transfer of data takes place from the transponder 14 to the reading unit 12. This data transfer also takes place in the opposite direction by means of electromagnetic coupling, for which in practice there are many options. A widely used method is e.g. so-called “load modulation”, in which the transponder 14 transmits its identification (and further data as necessary) not by means of its own output of radiation, but instead just makes use of the energy of the electromagnetic field to a greater or lesser extent in a modulated manner, which is in turn detected by the reading unit 12.

In this situation it is very advantageous that as a result of the shielding 23 the read-out of the data from the individual transponders 14 is not distorted by ambient effects and the read-out process is thus very reliable. Also no form of data encryption is necessary, since the shielding 20 also prevents any “eavesdropping attack” from external sources. Furthermore the RFID as represented is advantageously practically independent of legal restrictions with regard to the operating frequency and radiation power output used, in particular for the case of essentially complete absorption of the radiation power output by the shielding 20, that is to say, within the registration field that is bounded by the shielding.

With the construction as described can e.g. a shielding cage for a commercial load-carrying vehicle loading ramp be formed with dimensions (height, width, depth) in each case of the order of several metres.

As soon as the actual identification process according to FIG. 4 is completed, the door 22 is opened once again (FIG. 5) and the goods item 18 is taken out of the registration field 16 (FIG. 6).

The use of the shielding 20 enables interference-free operation with regard to any external interference sources such as e.g. electric motors (e.g. in forklift trucks, ventilating fans, drilling machines, etc.), fluorescent tubes, movement sensors, etc. In general terms electrical and electronic items of equipment that do not have appropriate shielding and emit electromagnetic radiation when in operation are a problem here. Interference sources of this type often emit over a very wide frequency range. A complicating factor that adds to the problem is that their interference activity often cannot be predicted; one must therefore anticipate random interference from various sources distributed over the working day.

In terms of radio legal directives RFID items of equipment are often classified as “short range devices” (SRD) and are authorised for one or a plurality of closely defined ranges of frequency. If the RFID system 10 works in one of these legally authorised ranges of frequency, the risk exists in practice that the system environment includes a large number of wireless applications to which the same frequency has been assigned. These items of equipment can take the form of e.g. radio thermometers, walkie-talkie sets, wireless headphones, etc. However the potential for interference from such radio equipment is also avoided by means of the shielding 20.

The same is true for targeted sabotage attacks using jamming transmitters from external sources. For example it is conceivable that a complete logistics centre could be paralysed by radiation targeted from an external jamming transmitter that does not even have to violate the radio directives in force. This risk is also removed by the use of the shielding 20.

A further advantage consists in the fact that operation of the RFID system 10 can ultimately be operated independently from legal directives concerning radio wavelengths and radiation power outputs, so that in individual cases the reliability of the identification process can, for example, be further increased in that a transmitter (e.g. integrated in the reading unit 12) is designed for a radiation power output that is dimensioned to be so large that operation of the system without the shielding 20 would be legally prohibited.

For the UHF range of frequencies regulations are in force across many countries, for example, ISO 18000-6a/b/c, ETSI EN 302 208 and ETSI EN 300 220, EPCglobal Class 1 Generation 2, etc. However e.g. for RFID in the frequency range from 865 to 869.5 MHz there are no standards that are in any way unified worldwide. Thus the standards that are in force in Western countries have not yet been adopted by countries in the Asia-Pacific region, in particular China. Advantageously with the present invention RFID systems can be used worldwide practically independently of the legal position.

A further advantage of the RFID system 10 consists in the fact that interference as a result of the simultaneous operation of a plurality of RFID reading units and/or a plurality of RFID systems in close vicinity no longer leads to the following typical problems as before: reduction of the reading rate (number of transponders read per second), false readings e.g. from neighbouring fields and thus reduction of reliability, reduction of reading accuracy, e.g. during the rapid transport of goods items or commodities on conveyor belts, etc. As a result of these problems there have up to now been significant operational restrictions in practice that have affected the productivity of the operation very disadvantageously.

The advantages of the system 10 as elucidated above simply presuppose that electromagnetic radiation power output in the relevant frequency or wavelength range is strongly damped to a greater or lesser extent on entry into the registration field 16 and/or on exit from the registration field 16.

In an advantageous form of embodiment this damping (for both directions of movement) is at least 60%, as further preferred at least 80%.

The advantages are however essentially independent from the circumstances as to whether the action of the shielding 20 is appreciably or in fact for the most part based on reflection of the electromagnetic radiation or not. Stated in simple terms it does not matter whether interference radiation from an external source is absorbed or reflected in the region of the shielding 20.

However the reflection of the RFID operating radiation generated in the interior of the registration field 16 at the shielding 20 affects the RFID identification process considerably, and makes possible some further surprising advantages in the use of shielding that reflects appreciably in the operating wavelength region.

A first advantage of reflecting shielding or shielding component (e.g. a side wall) consists in the fact that what would otherwise be “dead angles” within the registration field 16 can be supplied with an operating radiation power output, in that radiation can be reflected into these regions in a targeted manner.

A further advantage, which ensues in particular for shielding 20, which surrounds the registration field 16 for the most part, consists in the fact that as a result of the reflective capability of the shielding the radiation energy density in the registration field 16 can be appreciably increased. (This effect is used in a similar manner in e.g. laser resonators, i.e. there it is essential for the laser functionality (“confining”)). In the present invention the spatial registration field can e.g. with a prescribed RFID radiation power output, be significantly increased in size by means of this effect. Alternatively with a prescribed size for the registration field the effect can be used to reduce the RFID radiation power output. These considerations apply in equal measure to the energy or data transfer from an RFID transmitter to the transponders and from the transponders to the reading unit. What is important is simply that the radiation power output in the wavelength range in question is appreciably increased by its reflection within the registration field in terms of energy density.

In the following description of further examples of embodiment the same reference numbers are used for components acting in a similar manner, in each case supplemented by a lowercase letter to differentiate the form of embodiment. Here essentially only the differences from the example(s) of embodiment already described are entered into, and otherwise reference is expressly made to the description of previous examples of embodiment.

FIGS. 7 to 12 show a second example of embodiment of an RFID system 10a.

In distinction to the form of embodiment described above with reference to FIGS. 1 to 6, two opposing parts of the shielding 20a are designed as doors 22a-1 and 22a-2 respectively.

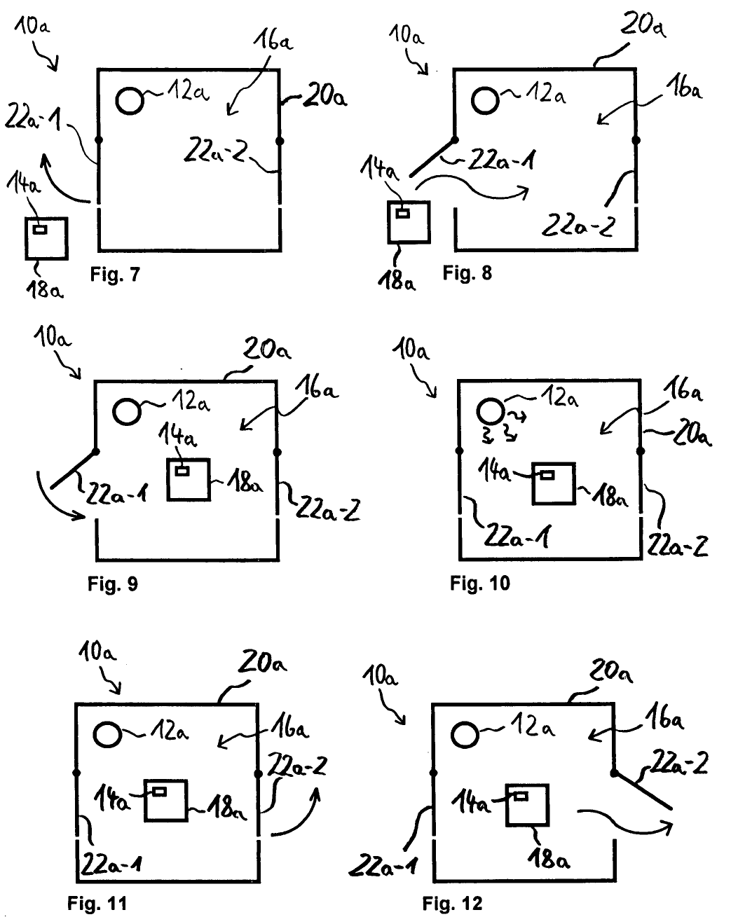

Goods items 18a fitted with transponders 14a are introduced through the door 22a-1 into a registration field 16a (FIG. 8) and after the actual identification process are removed through the door 22a-2 (FIG. 12). Otherwise the sequence of the RFID method is as for the system described above with reference to FIGS. 1 to 6.

This form of embodiment is particularly well suited for use in the control of material flows in commercial trade or production, e.g. for a “goods in” and “goods out” facility.

The doors 22a-1 und 22a-2 as described are, needless to say, only to be considered as examples, and can also be replaced according to the application by e.g. swing doors, roller gate devices, metal wire or metal cable curtains, etc.

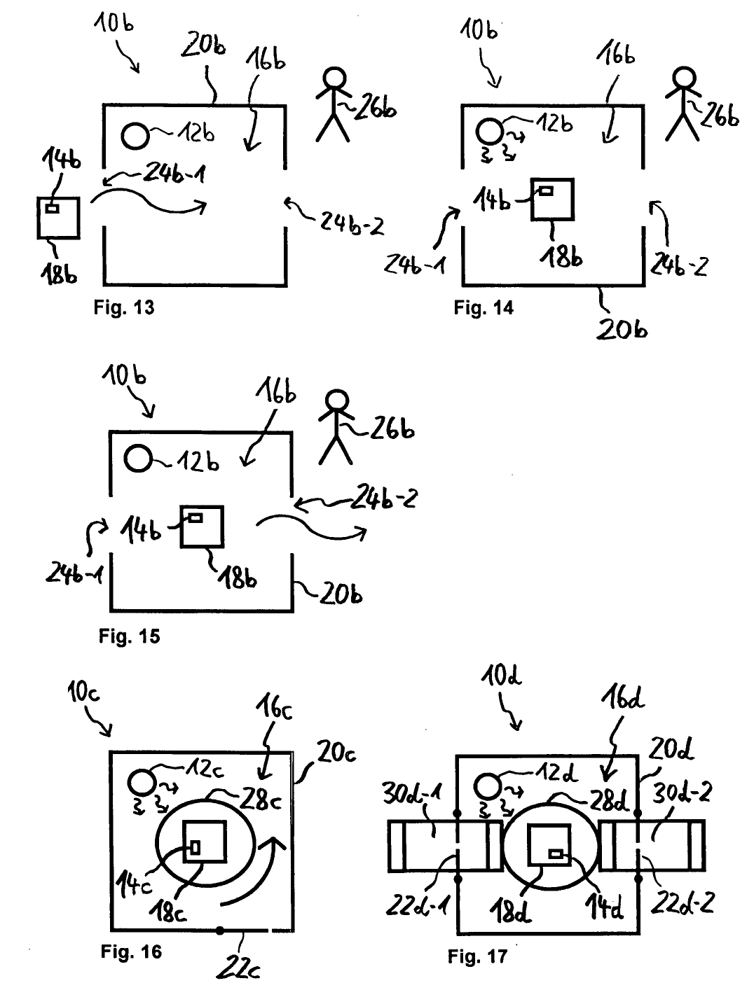

FIGS. 13 to 15 show a third example of embodiment of an RFID system 10b, which operates in a similar manner to the previously described system 10a.

In this example of embodiment however gate-type shielding components for channelling the objects or goods items concerned in and out are not used. Instead shielding 20b possesses passage openings (cut-outs) 24b-1 and 24b-2 for the introduction and removal of goods items 18b respectively.

FIG. 13 shows the situation as a goods item 18b fitted with a transponder 14b is introduced into an registration field 16b, FIG. 14 shows the situation during the actual identification process, and FIG. 15 shows the situation as the goods item 18b is channelled out.

A further advantageous feature for all examples of embodiment described is also illustrated in FIGS. 13 to 15. This consists in the fact that personnel or operators such as the person 26b represented are protected by the shielding used (20b in FIGS. 13 to 15) from any exposure to radiation emitted from the system 10b. This feature thus possesses significance in conjunction with health and safety protection at work. As a typical example a person is located at a “goods in” or “goods out” entrance or exit; this worker unloads or loads commercial load-carrying vehicles and on a loading ramp passes individual pallets in front of RFID reading units in order thereby to register all RFID transponders automatically. This has the end result that the workers are permanently exposed to electromagnetic radiation. This is not a problem as long as the radiation power output of the system is dimensioned to be appropriately low (and in conformance with legal directives). However in the context of the present invention it is precisely a feature of interest to increase appreciably the radiation power output available for registration, be it by means of an increased transmission power output and/or by a reflective capability of the shielding. In any event, however, the exposure of personnel to radiation can be drastically reduced precisely by the use of the shielding, in principle in fact far below the exposure provided by a conventional RFID system, even if the system according to the invention operates with much higher radiation power outputs.

Also in connection with health and safety protection at work as elucidated a further development is of interest for all forms of embodiment, in which the presence of objects (e.g. goods items) fitted with the transponders in the registration field, and/or the introduction of such objects into the registration field is detected (independently of the RFID registration), in order e.g. to activate the RFID system (to switch on the transmission power output), to close gate-like shielding components, to signal the presence of the objects acoustically and/or visually, etc. This can be provided in many different ways by a suitable sensor system. Also the removal of objects such as e.g. laden goods pallets from the registration field can in this manner be detected and signalled and/or used for the triggering of certain processes.

FIG. 16 shows a fourth example of embodiment of an RFID system 10c, which functions in a similar manner to the example described above with reference to FIGS. 1 to 6.

A special feature consists, however, in the fact that within the registration field 16c bounded by shielding 20c a positioning device is provided, here in the form of a turntable 28c, which serves to bring objects to be identified that are located on the turntable during the actual RFID registration process into different positions and/or orientations. The turntable 28c can advantageously be integrated into the shielding design and/or automatically controlled with the aid of sensors.

With the turntable 28c as represented e.g. a goods item 18c located on it can be rotated one or more times through 360° (cf. arrow) during the identification process. This allows for the circumstance in which, dependent on the materials and geometric arrangement conditions of the goods items or goods packaging concerned, “radio shadow regions” often exist such that the reliable registration of all transponders in a shipment is impeded. A stepwise and/or continuous rotation of the objects concerned (e.g. a pallet with several hundred metallic cans) provides a remedy here.

As an alternative or in addition to a rotation of the objects fitted with the transponders a tilting and/or translatory alteration of position or movement also comes into consideration. The turntable 28c symbolised in FIG. 16 could therefore also be designed e.g. as a lifting/turning table.

FIG. 17 shows a fifth example of embodiment of an RFID system 10d, in which a positioning device 28d is again provided in a similar manner to the example according to FIG. 16. However, in a manner similar to the example according to FIGS. 7 to 12, the system 10d possesses opposing doors 22d-1 and 22d-2 that are provided in each case for either the introduction or the removal respectively of the objects 18d. These doors are designed as twin-panel swing doors, are held in the closed position by spring forces, and are pushed open by the objects 18d passing through as they overcome the spring forces.

A further particular feature of the system 10d consists in the fact that by means of entry-side and exit-side conveyor belts 30d-1 and 30d-2 the introduction and removal of the objects 18d takes place in an automated manner. In the operation of the system 10d pallets can e.g. be placed onto the conveyor belt 30d-1, automatically transported into the registration field 16d, all transponders 14d registered (during a rotation of the turntable 28d), and are subsequently conveyed out of the registration field 16d once again on the opposite side.

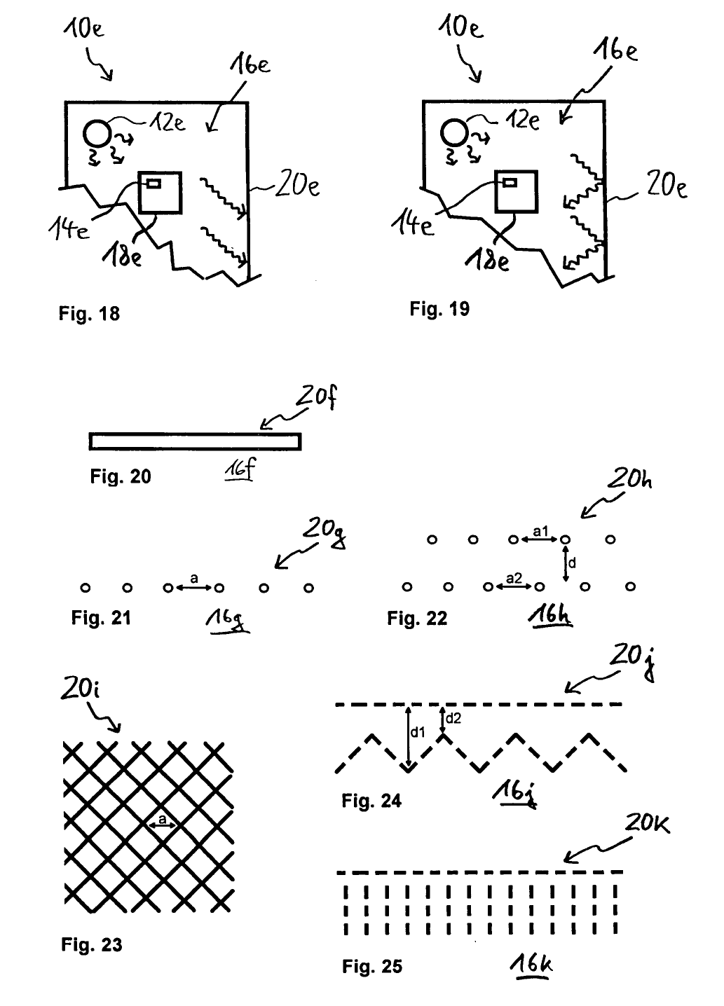

FIGS. 18 and 19 illustrate once again the difference that has already been elucidated above of a shielding effect with regard to the reflective capability of the shielding concerned. In the two figures a region of shielding 20e of an RFID system 10e is represented in each case. FIG. 18 illustrates the case of absorbing shielding 20e, whereas in FIG. 19 reflective shielding of the shielding 20e is represented.

FIGS. 20 to 25 illustrate various technical implementations of shielding or a shielding component (e.g. a flat extended shielding module). These shielding structures can advantageously be used with all the system examples described.

FIG. 20 illustrates shielding 20f in the form of a simple metal plate (e.g. a steel sheet). Deviating from this example e.g. a thin metal foil (e.g. with a thickness less than 0.2 mm) is also suitable, with which a carrier plate (e.g. made of plastic) is coated, or a textile shielding cover, as is of known art e.g. for EMC test arrays.

For the RFID frequencies of particular interest of the order of several hundred MHz the corresponding wavelengths are of the order of several centimetres up to about one metre. Using the principle of a “Faraday cage” an electrically conducting lattice or mesh structure is therefore also suitable as shielding. Examples of this are represented in FIGS. 21 to 25. Apart from the lower procurement and installation costs such structures are often also particularly advantageous because one “can see through” such structures.

FIG. 21 illustrates shielding 20g consisting of a series of individual metal profile bars. The metal bars are arranged equidistantly with a mutual separation distance a, for example in the vertical space from the floor to the ceiling of a room. The “characteristic separation distance” for this shielding structure, here the clearance between the metal bars, is preferably smaller than the wavelength of the electromagnetic radiation to be shielded by at least a factor 2. To achieve as good a shielding as possible the characteristic lattice or mesh separation distance should be dimensioned to be at least a factor 5 smaller than this wavelength, even better by at least a factor 10.

A simple option for increasing the shielding significantly consists in the use of two or more shielding layers arranged one behind another. FIG. 22 shows an example of such an arrangement. In this example of embodiment two layers of metal bars (each corresponding to FIG. 21) are arranged with lattice separation distances a1 and a2 respectively and a layer separation distance d. The separation distance d can be varied (as a function of the wavelength concerned) such that either the absorbing or the reflecting shielding effect is maximised. The two characteristic separation distances a1, a2 in the shielding plane can be selected to be of equal or different sizes.

FIG. 23 shows a shielding layer 20i consisting of a simple wire mesh or wire netting fence. In this manner very cost-effective shielding is obtained.

FIG. 24 shows shielding 20j consisting of two shielding layers, each of which is again designed as a lattice or mesh structure. A particular feature of this example of embodiment consists in the fact that one of the two layers is arranged in a zigzag shape. In this manner can e.g. an increased absorption effect be achieved, in particular if the difference between the indicated separation distances d1, d2 is of the order of the wavelength concerned.

FIG. 25 show shielding 20k in which, deviating from the embodiment according to FIG. 24, the zigzag layer is replaced by an arrangement of electrically conducting damping louvers, which are each arranged at right angles to the lengthwise plane of the shielding 20k and equidistant from one another.

FIG. 26 shows a further example of embodiment of an RFID system 10l with two reading units 12l-1 and 12l-2 for the identification of transponders 14l-1 and 14l-2 respectively.

The reading units 12l-1 and 12l-2 are, for example, in each case arranged in the vicinity of a supermarket checkout desk and serve to identify the goods items 18l-1 and 18l-2 passing by the checkout desk area in question, if these are guided past the respective reading unit (cf. arrows in FIG. 26).

A registration field 16l-1 of a first checkout desk area is bounded by a shielding layer 20l-1, in particular e.g. by a lattice or mesh structure of the type already elucidated above, in the direction towards a second checkout desk area. The same shielding layer 20l-1 bounds the second checkout desk area or registration field 16l-2 in the same manner in the direction towards the first checkout desk area. A further bounding of the registration field 16l-2 is formed by means of a second shielding layer 20l-2.

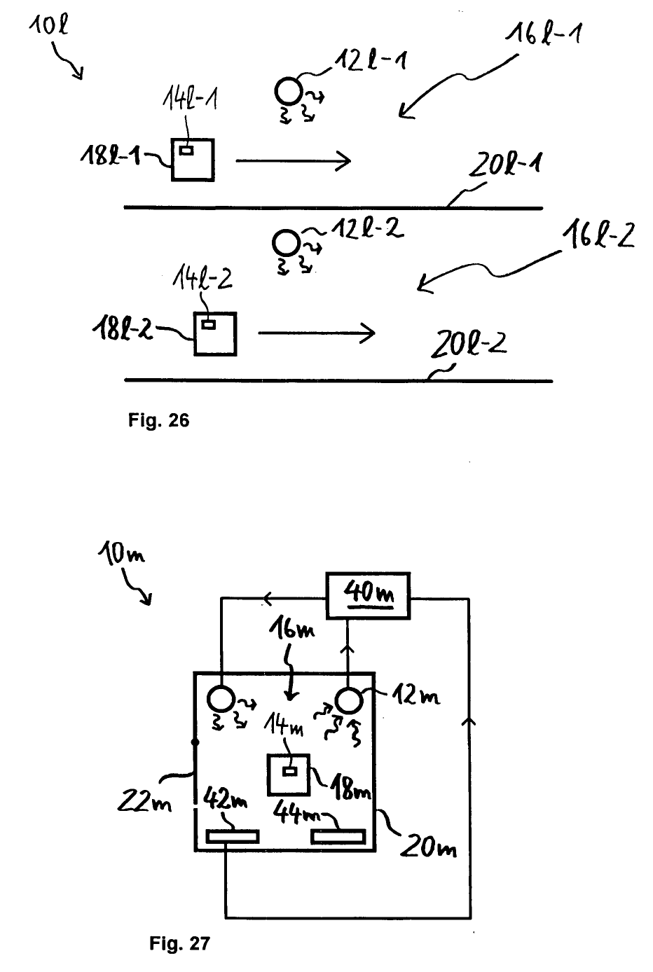

FIG. 27 shows a further example of embodiment of an RFID system 10m with a reading unit 12m for the identification of transponders 14m in a spatial registration field 16m.

In this example an RFID transmitter is not integrated in the reading unit 12m but is provided as a separate UHF transmitter 13m. Both the transmitter 13m and also the actual reading unit 12m have communications links with a computer 40m, which controls the system 12m in a programmed manner.

The computer 40m, for example, effects the switching on and off of the RFID components 12m, 13m, wherein in the example of embodiment represented the sensor signal of a sensor 42m is used for this purpose, which detects the presence of goods items in the registration field 16m.

44m designates a load dipole provided in this example of embodiment to absorb a radiation power output. “Loads” of this type can e.g. be advantageously introduced as a function of the actual geometrical conditions to achieve as even a radiation distribution as possible within the registration field.

Needless to say the individual special features of the system 10m represented in FIG. 27 can advantageously also be combined in conjunction with other embodiments of the system, such as e.g. with the examples of systems already described above.

The above examples of embodiment illustrate that with the invention a complete RFID solution can be created for interference-free operation by means of local shielding. For all embodiments it is usually advantageous to assemble the relevant shielding in modular form from modules of the same or different sizes. Here advantageously functional elements of the system concerned can be integrated onto or into the modules, (e.g. RFID transmitter, RFID reading units, sensors, load dipoles, electrical cabling, etc.).

In particularly advantageous forms of embodiment shielding is implemented with the simplest, in particular commercially available means such as wire mesh or profiled bars of metal. Shielding cages constructed in a modular manner of different sizes can be built from prefabricated parts. Advantageously it is possible to integrate additional elements therein for an automated production operation or material flow.

For example aerials for the RFID reading units can be already integrated into the shielding components, in any number or embodiment according to requirement. Particularly to be emphasised is the possibility of installing aerials during series production that are matched to the actual circumstances. Also sensors of a very wide variety of types, already installed or pre-installed (e.g. cabled up), can be pre-installed in plate-shaped shielding components. The sensors can e.g. take the form of movement sensors, photo sensors, light curtains, ultrasound sensors, temperature or radar sensors. By means of the sensors, for example, the aerial position can be controlled, a reading unit can be switched on and off, a folding gate serving as a gate-type shielding region can be opened and closed, etc.

The working sequence of the RFID method can advantageously be configured such that personnel during an automatic bulk registration of goods items (e.g. laden pallets) are located outside the registration field (e.g. cage) in a space that is free of radiation. In this manner very strict requirements of health and safety protection at work can be satisfied. Moreover reading units are not subjected to any fluctuations from external influences.

1. An RFID system with at least one reading unit (12) for the identification of transponders (14), which are located in a spatial registration field (16) of the reading unit,
characterised by shielding (20) that bounds the registration field (16).

2. The system according to claim 1, wherein
the shielding (20) surrounds the registration field (16) for the most part, in particular surrounds it essentially completely.

3. The system according to claim 1, wherein
the shielding (20) is designed such that it absorbs at least 50% of a radiation power output of the system.

4. The system according to claim 1, wherein
a radiation power output of the systems is dimensioned to be so large that operation of the system without the shielding (20) would be legally prohibited.

5. The system according to claim 1, wherein
the shielding (20) comprises an electrically conducting lattice or mesh structure.

6. The system according to claim 5, wherein
the lattice or mesh structure comprises metal bars and/or perforated metal plate and/or wire netting and/or wire mesh.

7. The system according to claim 5, wherein
a characteristic lattice or mesh separation distance (a) is dimensioned to be at least a factor 2 smaller than the wavelength of an electromagnetic radiation of the system.

8. The system according to claim 1, wherein
the shielding (20) comprises a plurality of shielding layers arranged one behind another.

9. The system according to claim 1, wherein
at least one part of the shielding (20) is designed as a gate (22), which in an open position permits the introduction and removal of objects (18) fitted with transponders (14), and which shields in a closed position.

10. The system according to claim 9, comprising at least two gates (22), of which one is provided for the introduction of the objects (18), and another is provided for their removal.

11. An RFID method for the identification of transponders (14), which are located in a spatial registration field (16) of a reading unit (12),
characterised in that the registration field is shielded.

12. The method according to claim 11, wherein
the registration field (16) is surrounded by shielding (20) for the most part, in particular essentially completely.

13. The method according to claim 11, wherein
an absorption of at least 50% of a radiation power output of the reading unit (12) is provided by the shielding (20).

14. The method according to claim 11, carried out with a radiation power output, which without the use of the shielding (20) would be legally prohibited.

15. The method according to claim 11, wherein
at least a part of the shielding (20) can be moved in a gate-like manner between an open position and a closed position, objects (18) fitted with transponders are introduced and/or removed in the open position, and in the closed position the identification of the transponders (14) is carried out.

16. The method according to claim 15, wherein
at least two gate-like moveable shielding parts (22) are provided, of which one is used for the introduction of the objects (18), and another is provided for their removal.
